(19) United States
(12) Patent Application Publication
(10) Pub. No.: US 2024/0403086 A1
(43) Pub. Date: Dec. 5, 2024

(54) GENERATING AND PROVIDING MORPHING ASSISTANT INTERFACES THAT TRANSFORM ACCORDING TO ARTIFICIAL INTELLIGENCE SIGNALS

(71) Applicant: Dropbox, Inc., San Francisco, CA (US)

(72) Inventors: Devin Mancuso, San Francisco, CA (US); Jason Stakelon, Sausalito, CA (US); Richard Chan, San Francisco, CA (US)

(21) Appl. No.: 18/342,469

(22) Filed: Jun. 27, 2023

Related U.S. Application Data
(60) Provisional application No. 63/505,805, filed on Jun. 2, 2023.

(51) Int. Cl. G06F 9/451; G06N 3/042; G06N 3/0455

(52) U.S. Cl. CPC G06F 9/453; G06N 3/042; G06N 3/0455

(57) ABSTRACT

The present disclosure is directed toward systems, methods, and non-transitory computer readable media for generating and providing an intelligent assistant interface that integrates with a large language model and a knowledge graph to adaptively change its appearance for presenting and interacting with different content items from various sources. In some embodiments, the disclosed systems provide an intelligent assistant interface that includes a set of interface elements selectable to interact with a large language model. Based on an input intent, the disclosed systems can utilize the large language model to analyze a knowledge graph for accessing and/or generating content items for display within the intelligent assistant interface.

### CROSS REFERENCE TO RELATED APPLICATIONS

This application claims the benefit of and priority to U.S. Provisional Patent Application No. 63/505,805, filed Jun. 2, 2023, entitled GENERATING AND PROVIDING MORPHING ASSISTANT INTERFACES THAT TRANSFORM ACCORDING TO ARTIFICIAL INTELLIGENCE SIGNALS, which is incorporated herein by reference in its entirety.

### BACKGROUND

Advancements in computing devices and networking technology have given rise to a variety of innovations in cloud-based digital content storage and access. For example, online digital content systems can provide access to digital content items across devices all over the world. Existing systems can also synchronize changes to shared digital content across different types of devices operating on different platforms. Indeed, modern online digital content systems can provide access to digital content for users to collaborate across diverse physical locations and over a variety of computing devices. Despite these advances, however, existing digital content systems continue to suffer from a number of disadvantages, particularly in terms of flexibility and efficiency.

As just suggested, some existing digital content systems are inflexible. In particular, many existing systems are rigidly fixed to the conventional paradigm of providing access to content items using files and folders which are navigable via interaction with client devices. For example, some existing systems provide access to stored content items via drill-down navigation within a hierarchy of folders and/or via a search function to locate a directory for a searched content item. To access other types of content items, such as websites or other web-based content items not stored on a client device (and not stored in another folder directory on a cloud server for a user account), existing systems often require the use of an entirely separate application (e.g., apart from a folder/file management application). Indeed, to provide access to web-based content items and stored content items, existing systems can require separate computer applications (e.g., a browser application and a file management application), even for accessing content items of a common topic. Beyond this, should user accounts engage in communication regarding one or more content items and/or editing (or otherwise interacting with) the content items, many existing systems require further separate applications to facilitate such communication and editing (or other interaction).

Due at least in part to their inflexibility, many existing digital content systems are also inefficient. To elaborate, many existing systems consume excessive amounts of computer resources, such as processing power and memory, by running separate applications for accessing stored content items, accessing web-based content items, and communicating between client devices. In addition, some existing systems provide inefficient user interfaces that require many navigational operations performed via client devices to access desired content and/or functionality. For example, existing systems often require many drill-down operations to navigate folders to access a content item. Even for systems that facilitate faster content item access through searching, such systems nevertheless require many navigational operations across different interfaces and applications to access content items of different types, to communicate across client devices regarding the content items, and/or to edit (or otherwise interact with) the content items.

Thus, there are several disadvantages with regard to existing digital content systems.

### SUMMARY

This disclosure describes one or more embodiments of systems, methods, and non-transitory computer readable storage media that provide benefits and/or solve one or more of the foregoing and other problems in the art. For instance, the disclosed systems generate and provide an intelligent assistant interface that integrates with a large language model and a knowledge graph to adaptively change its appearance for presenting and interacting with different content items from various sources. In some embodiments, the disclosed systems provide an intelligent assistant interface that includes a set of interface elements selectable to perform predicted and/or high frequency actions or processes. In one or more embodiments, the disclosed systems provide an intelligent assistant interface that includes a query panel for entering text queries. The disclosed systems can utilize a large language model to analyze a knowledge graph for accessing and/or generating content items corresponding to a text query and/or a selected interface element. In some cases, the disclosed systems analyze a knowledge graph that defines relationships between content items and user accounts within an ontology to perform one or more processes (e.g., a series of successive processes using different computer applications within a workflow) to generate and provide a content item for display within the intelligent assistant interface.

### BRIEF DESCRIPTION OF THE DRAWINGS

This disclosure will describe one or more example implementations of the systems and methods with additional specificity and detail by referencing the accompanying figures. The following paragraphs briefly describe those figures, in which:

FIG. 1 illustrates a schematic diagram of an example environment of a morphing interface system in accordance with one or more embodiments;

FIG. 2 illustrates an example overview of generating and transforming an intelligent assistant interface in accordance with one or more embodiments;

FIG. 3 illustrates an example diagram for utilizing a large language model to analyze a knowledge graph in accordance with one or more embodiments;

FIG. 4 illustrates an example diagram for executing processes for a multi-application workflow in accordance with one or more embodiments;

FIG. 5 illustrates an example intelligent assistant interface in accordance with one or more embodiments;

FIG. 6 illustrates an example intelligent assistant interface including a generated content item in accordance with one or more embodiments;

FIG. 7 illustrates an example intelligent assistant interface for a question-and-answer conversation in accordance with one or more embodiments;

FIG. 8 illustrates an example intelligent assistant interface including an embedded web browser in accordance with one or more embodiments;

FIG. 9 illustrates an example intelligent assistant interface in a different shape for an embedded web browser in accordance with one or more embodiments;

FIG. 10 illustrates an example flowchart of a series of acts for generating, providing, and transforming an intelligent assistant interface in accordance with one or more embodiments;

FIG. 11 illustrates a block diagram of an exemplary computing device in accordance with one or more embodiments; and

FIG. 12 illustrates an example environment of a networking system having the morphing interface system in accordance with one or more embodiments.

### DETAILED DESCRIPTION

This disclosure describes one or more embodiments of a morphing interface system that can generate, provide, and transform an intelligent assistant interface integrated with a large language model and a knowledge graph. To elaborate, the morphing interface system can generate and provide an intelligent assistant interface for interacting with a large language model to generate and identify content items using a knowledge graph of a cloud-based content management system. For example, the morphing interface system can receive a user interaction for performing a particular task or action, or for answering a particular question, and the morphing interface system can utilize a large language model to analyze a (user-account-specific) knowledge graph to generate or identify a corresponding content item to provide for display within an intelligent assistant interface. As part of providing a generated or identified content item for display, the morphing interface system can morph or transform the intelligent assistant interface according to the (type of) content item. For instance, the morphing interface system can transform the (size and shape of the) intelligent assistant interface to fit or accommodate a window of an embedded application for displaying the content item, such as an embedded web browser, an embedded image editor, an embedded email client, or some other embedded form of a computer application.

As just mentioned, the morphing interface system can provide an intelligent assistant interface for display on a client device. For example, the morphing interface system can provide an intelligent assistant interface as a floating panel or a desktop client within a user interface of a client device (e.g., a desktop interface). Within the intelligent assistant interface, the morphing interface system can provide interface elements for interacting with a large language model (e.g., ChatGPT or a proprietary model integrated with a cloud-based content management system), such as a query panel for entering text queries and/or selectable elements for performing actions.

Based on receiving a user interaction with an interface element to either enter a text query or to select an element for performing an action, the morphing interface system can utilize a large language model to process the user interaction. In some embodiments, the morphing interface system processes the user interaction to generate a content item to provide in response to the user interaction in one or more of the following methods: i) performing a predefined process for a frequent important action in response to a selection of an action-specific button, ii) generating an answer to a text-entered question, or iii) executing a workflow using multiple systems, applications, and/or networks to complete a high-order task that requires multifaceted response generation across multiple tasks, data sources, and/or combinations of various outputs.

To perform any of the above tasks, in one or more embodiments, the morphing interface system utilizes a knowledge graph integrated with the large language model. To elaborate, the morphing interface system can generate and analyze knowledge graphs for individual user accounts of a content management system and/or more globally for an entire user account base of (or a set of user accounts within) a content management system. Using a large language model to predict input intent from a user interaction, the morphing interface system can further analyze a knowledge graph to identify or generate a content item in response to the user interaction (e.g., by performing a predefined process, generating a response to a question, or executing a workflow). In some embodiments, the morphing interface system learns user account behavior over time and automatically performs certain learned processes and/or generates new interface elements to define new frequent actions (and selectable to perform the new frequent actions).

As mentioned, the morphing interface system can also transmogrify, transform, or morph an intelligent assistant interface. In certain embodiments, the morphing interface system transforms a size and/or shape of an intelligent assistant interface based on a (type of) content item generated or identified by the large language model. In some cases, the morphing interface system embeds (a window of) an external application (or separate windows for embedding multiple external applications) within the intelligent assistant interface to present or display a content item generated or identified (from a knowledge graph) in response to user interaction. For instance, the morphing interface system embeds a web browser, an email client, an image editor, or some other application into the intelligent assistant interface. In some embodiments, the morphing interface system further morphs the intelligent assistant interface according to the embedded application to include features/elements of the embedded application and features/elements for interacting with the large language model.

As suggested above, through one or more of the embodiments mentioned above (and described in further detail below), the morphing interface system can provide several improvements or advantages over existing digital content systems. For example, the morphing interface system can improve flexibility over prior systems. Indeed, while some prior systems are rigidly fixed to the traditional folder-and-file hierarchy for accessing content items, the morphing interface system can utilize an intelligent assistant interface to adaptively access and provide content items from a wide range of locations, including locally stored content items and content items hosted on a server (e.g., a website or a cloud-stored content item). Even compared to existing systems that can access different types of content items, such as websites and stored content items, the morphing interface system is more flexible as the intelligent assistant interface is adaptive to provide access to content items from web locations and other server locations (as determined by a large language model analyzing a knowledge graph) without requiring entirely separate applications to access web-based content items than those for accessing stored content items (stored locally or on the cloud). Moreover, in cases where user accounts engage in communication regarding one or more content items and/or engage in editing (or otherwise interacting with) the content items, the morphing interface system integrates external applications such as web browsers, chat applications, and email clients directly within the intelligent assistant interface to facilitate interaction with (or about) content items, unlike many existing systems which require separate applications to facilitate such additional interaction.

Due at least in part to its improved flexibility, the morphing interface system can also improve efficiency over existing digital content systems. For example, as opposed to prior systems that consume excessive amounts of computer resources, such as processing power and memory, by running separate applications for accessing stored content items, accessing web-based content items, and communicating between client devices, the morphing interface system can utilize a single interface—the intelligent assistant interface—to condense many functions into a single application and a single interface. For example, the morphing interface system can embed external applications directly within the intelligent assistant interface, thereby reducing the navigational burden of prior systems that require many navigational operations across different interfaces and applications. In addition, the morphing interface system reduces the number of drill-down operations to access a content item by providing interface elements for directly accessing content items via a large language model (e.g., with a single click or a single text query). Consequently, the morphing interface system not only improves navigational efficiency but also improves computational efficiency by reducing the computing resources required to run many different applications at once.

As illustrated by the foregoing discussion, the present disclosure utilizes a variety of terms to describe features and benefits of the morphing interface system. Additional detail is hereafter provided regarding the meaning of these terms as used in this disclosure. As used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As a subset of content items, a “web content item” or a “web-based content item” refers to a content item accessible via the internet, such a webpage, a website, or a cloud-based content item not accessed locally. For example, a web content item can refer to an internet-based content item, such as a content item identified by, or located at, a URL address. A web content item can include a content item coded or defined by HTML, JavaScript, or another internet language. In some cases, a web content item can include a content item accessible via HTTP(S) protocol (or some other internet protocol) via a web browser.

As mentioned above, the morphing interface system can generate or identify content items using a large language model. As used herein, the term “large language model” refers to a machine learning model trained to perform computer tasks to generate or identify content items in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify content items based on various contextual data, including graph information from a knowledge graph and/or historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the morphing interface system utilizes a large language machine learning model in the form of a neural network.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training, such a neural network may become a large language model.

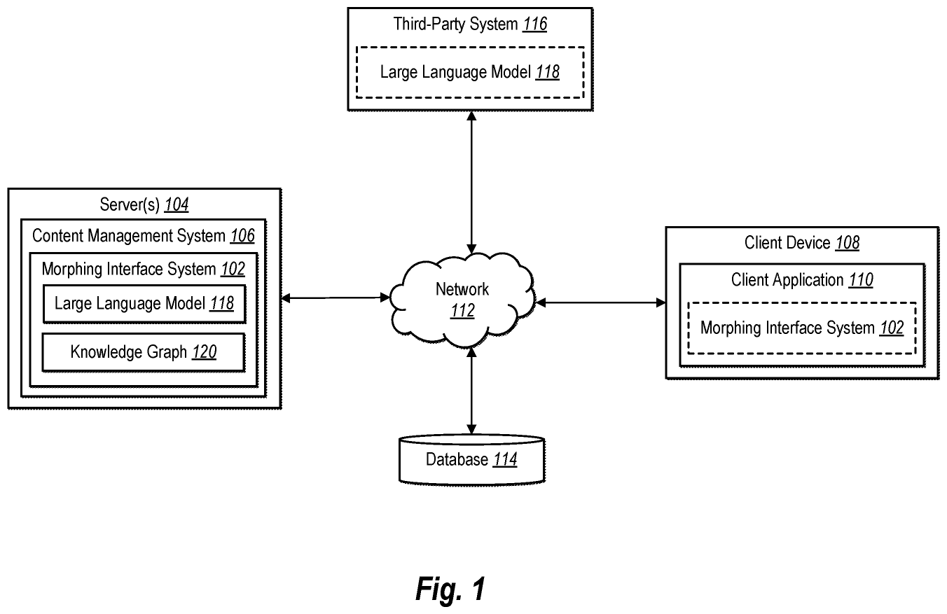

Additional detail regarding the morphing interface system will now be provided with reference to the figures. For example, FIG. 1 illustrates a schematic diagram of an example system environment for implementing a morphing interface system 102 in accordance with one or more implementations. An overview of the morphing interface system 102 is described in relation to FIG. 1. Thereafter, a more detailed description of the components and processes of the morphing interface system 102 is provided in relation to the subsequent figures.

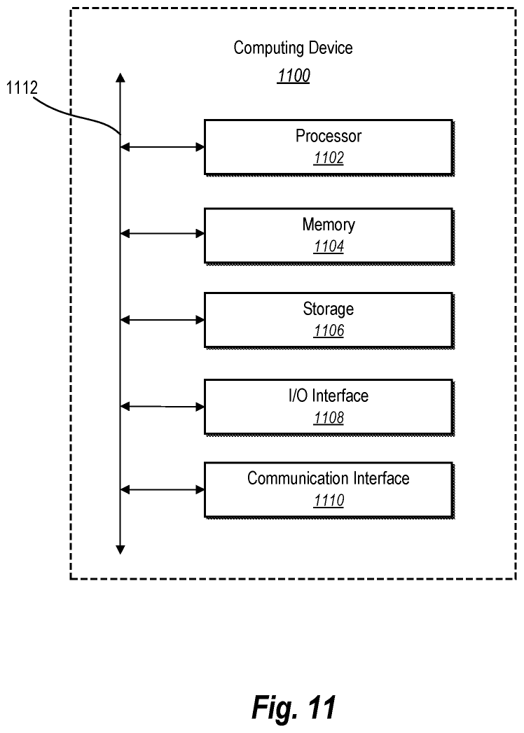

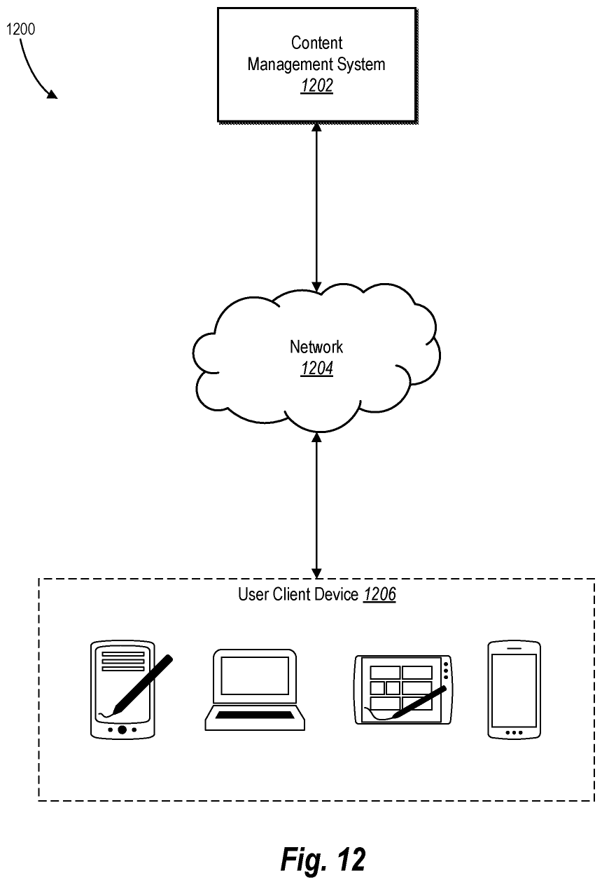

As shown, the environment includes server(s) 104, a client device 108, a database 114, a third-party system 116, and a network 112. Each of the components of the environment can communicate via the network 112, and the network 112 may be any suitable network over which computing devices can communicate. Example networks are discussed in more detail below in relation to FIGS. 11-12.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIGS. 11-12. The client device 108 can communicate with the server(s) 104 and/or the database 114 via the network 112. For example, the client device 108 can receive user input from a user interacting with the client device 108 (e.g., via the client application 110) to, for instance, access, generate, modify, or share a content item, to collaborate with a co-user of a different client device, or to select a user interface element. In addition, the morphing interface system 102 on the server(s) 104 can receive information relating to various interactions with content items and/or user interface elements based on the input received by the client device 108 (e.g., to access content items, interacting with content blocks, or perform some other action).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including an intelligent assistant interface for presenting content items (e.g., via embedded applications) from the content management system 106 or from other network locations.

As illustrated in FIG. 1, the example environment also includes the server(s) 104. The server(s) 104 may generate, track, store, process, receive, and transmit electronic data, such as digital content items, interface elements, interactions with digital content items, interactions with interface elements, and/or interactions between user accounts or client devices. For example, the server(s) 104 may receive data from the client device 108 in the form of a text query to perform a particular task or to generate a particular content item. In addition, the server(s) 104 can transmit data to the client device 108 in the form of an intelligent assistant interface that includes a generated content item resulting from performing the requested task. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the morphing interface system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts, including user accounts in collaboration with one another. In some embodiments, the morphing interface system 102 and/or the content management system 106 utilize the database 114 to store and access information such as digital content items.

As also illustrated in FIG. 1, the morphing interface system 102 can include a large language model 118 and a knowledge graph 120. In particular, the morphing interface system 102 can utilize the large language model 118 that is integrated with (e.g., trained by data from) the content management system 106 and/or the knowledge graph 120. For example, the knowledge graph 120 can store or encode relationship information to define relationships between user accounts and content items within the content management system 106 (and/or housed at other server locations). From the knowledge graph 120, the large language model 118 can generate or identify content items to provide to the client device 108 in response to a user interaction via an intelligent assistant interface. For instance, the large language model 118 can generate a contact card for a user account most closely related to a text query received from the client device 108, as determined via the knowledge graph 120.

FIG. 1 further illustrates a third-party system 116. In particular, the third-party system 116 can host or house a large language model 118 for access by the morphing interface system 102. For example, the third-party system 116 can include a server location hosting the large language model 118 that is external to the morphing interface system 102. In some cases, the third-party system 116 is external to the morphing interface system 102, but the morphing interface system 102 can nevertheless access and utilize the large language model 118 to generate or identify content items by analyzing a knowledge graph 120 on the server(s) 104.

Although FIG. 1 depicts the morphing interface system 102 located on the server(s) 104, in some implementations, the morphing interface system 102 may be implemented by (e.g., located entirely or in part on) one or more other components of the environment. For example, the morphing interface system 102 may be implemented by the client device 108, and/or a third-party device. For example, the client device 108 can download all or part of the morphing interface system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the morphing interface system 102, bypassing the network 112. As another example, the environment can include the database 114 located external to the server(s) 104 (e.g., in communication via the network 112) or located on the server(s) 104, on the third-party system 116, and/or on the client device 108.

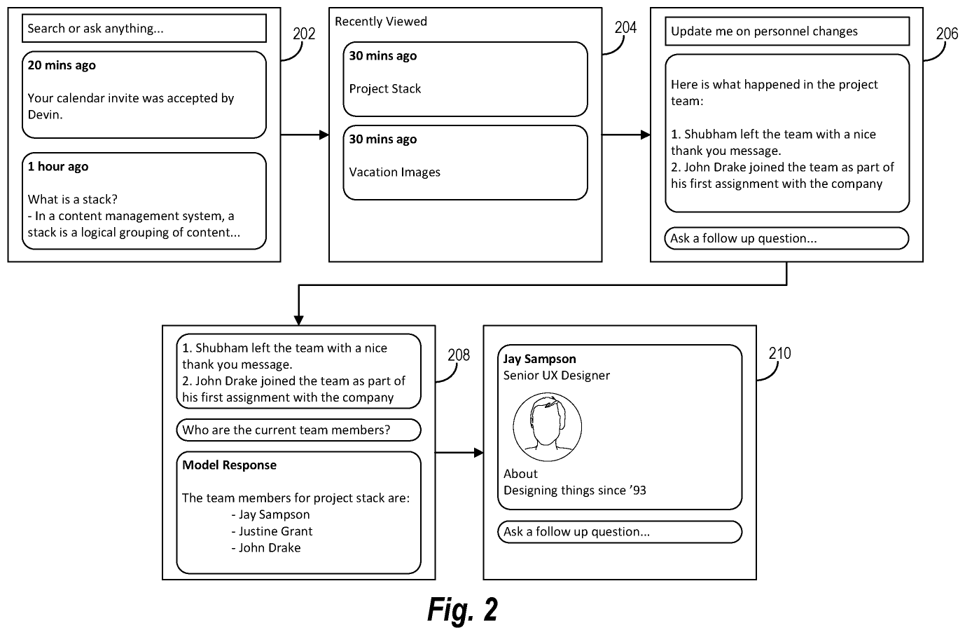

As mentioned above, the morphing interface system 102 can generate, provide, and transform an intelligent assistant interface. In particular, the morphing interface system 102 can provide an intelligent assistant interface that integrates with a large language model and a knowledge graph and which morphs to adapt to one or more (types of) content items displayed (e.g., within respective embedded applications). FIG. 2 illustrates an example overview of generating, providing, and transforming an intelligent assistant interface in accordance with one or more embodiments. Additional detail regarding the various methods and processes described in relation to FIG. 2 is provided thereafter with reference to subsequent figures.

As illustrated in FIG. 2, the morphing interface system 102 provides a first intelligent assistant interface 202. In particular, the morphing interface system 102 provides a first version of an intelligent assistant interface as a floating panel that accompanies, or is presented within, a desktop interface of a client device. For example, the morphing interface system 102 provides the first intelligent assistant interface 202 in response to a hotkey (e.g., cmd+e) or detection of a trigger event (e.g., automatic detection that a user account is likely to perform an action that could be done via the intelligent assistant interface). As shown, the first intelligent assistant interface 202 includes a query panel for entering text queries and further includes one or more recommendations specific to a user account (e.g., content item recommendations or conversation recommendations pertaining to content items).

In some embodiments, the morphing interface system 102 provides a variation of an intelligent assistant interface, such as a (moveable/hovering) voice-indicator widget. For instance, in response to predicting, detecting, or determining (based on current and historical user behavior) that a user account is going to interact with an intelligent assistant, the morphing interface system 102 provides a voice widget to indicate activation of a microphone to receive voice or speech input. In some cases, the morphing interface system 102 provides selectable elements within the first intelligent interface 202 to provide speech or voice input for entering a search query. Based on receiving a voice query, the morphing interface system 102 further performs a speech to text conversion to generate a text query for generating responses and evolving the intelligent assistant interface.

In some cases, the morphing interface system 102 determines content items or conversations to recommend by utilizing a large language model to analyze a knowledge graph associated with a user account and/or to analyze user account behavior to determine probabilities of user interaction with various content items and user accounts. Based on determining a user interaction probability with a content item that satisfies a threshold probability, the morphing interface system 102 generates a recommendation that includes the content item. Similarly, based on determining a user interaction probability with a conversation (e.g., with one or more user accounts communication on a particular topic or content item) that satisfies a threshold probability, the morphing interface system 102 generates a recommendation that includes the conversation. As shown, the morphing interface system 102 generates a first recommendation based on historical user account behavior to indicate that a calendar invite was accepted. The morphing interface system 102 generates a second recommendation for a conversation regarding the definition of a stack based on analyzing a knowledge graph and user account behavior.

As further illustrated in FIG. 2, the morphing interface system 102 generates and provides a second intelligent assistant interface 204. More specifically, the morphing interface system 102 modifies the first intelligent assistant interface 202 to provide the second intelligent assistant interface 204 in response to receiving an indication of a user interaction to perform a search. For example, the morphing interface system 102 receives a text query entered via the first intelligent assistant interface 202, and the morphing interface system 102 generates or identifies one or more content items corresponding to the text query, including an individual content item corresponding to the text query (“Project Stack”), a collection or a set of content items about a topic corresponding to the text query (“Vacation Images”), and/or selectable elements for viewing and participating in conversations among user accounts that correspond to (a topic of) the text query. To generate the content items for the second intelligent assistant interface 204, the morphing interface system 102 utilizes a large language model to analyze the text query, to analyze a knowledge graph of the user account, and to analyze user account behavior (e.g., by encoding a topic-specific feature vector for the text query in a latent vector space and comparing the query vector with similarly encoded vectors for content items, conversations, and user accounts).

As shown, the morphing interface system 102 further generates and provides a third intelligent assistant interface 206. In particular, the morphing interface system 102 generates the third intelligent assistant interface 206 by modifying or transforming the second intelligent assistant interface 204. To elaborate, the morphing interface system 102 modifies the intelligent assistant interface in response to receiving a user interaction entering a text query (“Update me on personnel changes”). Indeed, the morphing interface system 102 can modify the intelligent assistant interface based on user interactions and/or based on determining which (type of) content item to provide for display in response to a user interaction. For instance, the morphing interface system 102 generates the “Model Response” in response to the text query and modifies the intelligent assistant interface accordingly.

As further illustrated in FIG. 2, the morphing interface system 102 can generate and provide a fourth intelligent assistant interface 208. More particularly, the morphing interface system 102 can modify the third intelligent assistant interface 206 to include additional information for the fourth intelligent assistant interface 208. In some embodiments, the morphing interface system 102 receives a follow-up query (“Who are the current team members”) via the third intelligent assistant interface 206 and thus expands (or otherwise morphs) the third intelligent assistant interface 206 to include an additional response within the fourth intelligent assistant interface 208. Indeed, the morphing interface system 102 generates the additional response using the large language model to analyze a knowledge graph for identifying user accounts that are the team members of Project Stack. For instance, the morphing interface system 102 utilizes the large language model to identify user accounts designated as project managers or leads for Project Stack within an organizational ontology and/or to identify user accounts whose nodes are within a threshold distance of a Project Stack node within the knowledge graph (e.g., based on user account behavior). As shown, the morphing interface system 102 can continually transform the intelligent assistant interface to include additional responses within a conversation between a user account and a large language model (e.g., like the transformation from the third intelligent assistant interface 206 to the fourth intelligent assistant interface 208).

Additionally, the morphing interface system 102 can generate and provide a fifth intelligent assistant interface 210. Specifically, the morphing interface system 102 modifies the fourth intelligent assistant interface 208 to generate the fifth intelligent assistant interface 210. For example, the morphing interface system 102 provides the fifth intelligent assistant interface 210 in response to a user interaction selecting a link (e.g., one of the names of the team members from the fourth intelligent assistant interface 208) to identify and display a content item. As shown, the morphing interface system 102 accesses the selected content item (e.g., a profile page for Jay Sampson) to display within the intelligent assistant interface. In some embodiments, the morphing interface system 102 determines a content type for the selected content item and further identifies a computer application for presenting or interacting with content items of the type. Accordingly, the morphing interface system 102 modifies or morphs the intelligent assistant interface to include a window for an embedded computer application, such as a web browser, an email client, an image editor, or some other computer application. As shown, the morphing interface system 102 transforms the intelligent assistant interface into a hybrid assistant-browser interface to include an embedded browser window along with interface elements for interacting with a large language model.

Indeed, the morphing interface system 102 can morph or transmogrify an intelligent assistant interface according to content types for content items generated or identified for display. In some cases, the morphing interface system 102 morphs the intelligent assistant interface to have a different size and shape. In these or other cases, the morphing interface system 102 morphs the intelligent assistant interface to include different functionality (e.g., from embedded applications and/or for interacting with a large language model in different ways, depending on content type or depending on where in a predicted workflow a user account is providing input). In one or more embodiments, the morphing interface system 102 can transform an intelligent assistant interface based on contextual data and/or without requiring direct user interaction with the intelligent assistant interface. For example, the morphing interface system 102 can monitor user account behavior and can compare current behavior with past behavior patterns to predict next actions or future user account actions (e.g., via a large language model). Based on such a prediction, the morphing interface system 102 can morph the intelligent assistant interface to include interface elements corresponding to the predicted action (e.g., changing its size, shape, and/or function). Accordingly, the morphing interface system 102 provides an intelligent assistant interface that adapts in appearance and function according to current (and/or predicted future) circumstances of a client device, providing immediate access to functions of applications that a user account is predicted to interact with (e.g., at various junctures along a predicted workflow).

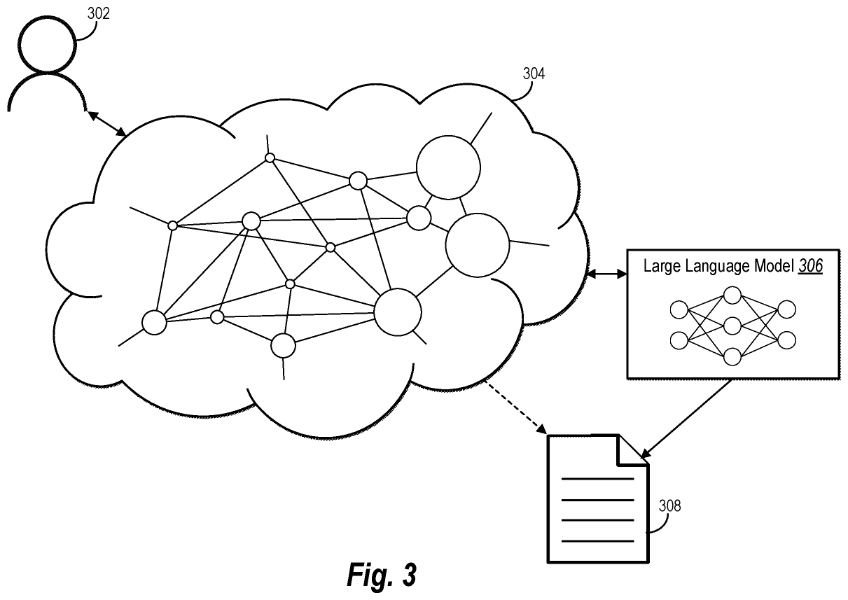

As mentioned above, in one or more embodiments, the morphing interface system 102 utilizes a large language model and/or a knowledge graph to generate or identify content items to provide for display within an intelligent assistant interface. In particular, the morphing interface system 102 generates or identifies a content item based on user interaction via the intelligent assistant interface by analyzing the user interaction together with a knowledge graph (e.g., via a large language model). FIG. 3 illustrates generating or identifying a content item to provide for display within an intelligent assistant interface using a large language model and a knowledge graph in accordance with one or more embodiments.

As illustrated in FIG. 3, the morphing interface system 102 generates and utilizes a knowledge graph 304 for a user account 302. In some embodiments, the morphing interface system 102 generates a user-account-specific knowledge graph 304 for the user account 302, where the knowledge graph defines relationships associated with the user account 302—including relationships with other user accounts and content items. In certain embodiments, the morphing interface system 102 generates a system-wide knowledge graph that includes a node for the user account 302 and that includes nodes for content items and user accounts within an entirety of the content management system 106 and/or for a particular organizational ontology (e.g., a company or a team of collaborating user accounts). Indeed, the morphing interface system 102 can generate multiple knowledge graphs, including one that is specific to the user account 302 and one that is system-wide (or organization-wide).

As shown, the morphing interface system 102 generates the knowledge graph 304 using nodes to represent user accounts and content items and using edges to represent relationships between the nodes (e.g., where shorter distances represent stronger relationships than longer distances). To generate the knowledge graph 304, the morphing interface system 102 monitors or detects user account behavior over time. For example, the morphing interface system 102 monitors accesses, shares, comments, edits, receipts, clips (e.g., generating content items from other content items), and/or other user interactions over time to determine frequencies, recencies, and/or overall numbers of user interactions (of the user account 302, of collaborating user accounts with the user account 302, and/or of similar user accounts) with content items and/or with other user accounts. In some cases, the morphing interface system 102 further utilizes the large language model 306 (and/or another neural network) to determine topics associated with content items. Indeed, in some embodiments, the morphing interface system 102 generates, modifies, and maintains the knowledge graph 304 using one or more machine learning models (e.g., neural networks) to predict relationships between content items and user accounts.

As shown, the knowledge graph 304 includes nodes and edges for content items and user accounts associated with the user account 302. In some cases, the morphing interface system 102 generates larger nodes for higher frequencies of interaction of the user account 302 with respective content items and user accounts. In these or other cases, the morphing interface system 102 generates edges to have lengths or distances that indicate closeness of relationships between nodes. For example, the morphing interface system 102 generates edges between nodes to reflect frequencies and/or recencies of interaction with respective content items (or topics) and user accounts. In some embodiments, the morphing interface system generates edges to reflect the types of user interactions with the content items and user accounts (e.g., where edits indicate closer relationships than shares, which in turn indicate closer relationships than accesses). Indeed, the morphing interface system 102 can generate the knowledge graph 304 based on combinations of numbers, recencies, frequencies, and types of user interactions by the user account 302 and other user accounts related to (e.g., collaborating with or within the same ontology as) the user account 302.

As further illustrated in FIG. 3, the morphing interface system 102 utilizes a large language model 306 to analyze the knowledge graph 304. More specifically, the morphing interface system 102 utilizes the large language model 306 to analyze a user interaction (e.g., a text query or a selection of an interface element) from an intelligent assistant interface and, in response, to analyze the knowledge graph 304 to generate or identify a content item 308. For example, the morphing interface system 102 generates or identifies the content item 308 as a content item with a high probability of matching a text query and/or as a generated content item based on a selected interface element.

To generate or identify the content item 308, the morphing interface system 102 determines an input intent from the user interaction. To elaborate, the morphing interface system 102 utilizes the large language model 306 to process the user interaction, such as a selection of an interface element for performing one or more predefined processes or an entered text query, to determine the input intent. For example, the morphing interface system 102 utilizes the large language model 306 to generate a set of input intent predictions using model parameters learned during model training (e.g., training on large sets of user interactions and corresponding ground truth input intents). In some cases, the morphing interface system 102 selects an input intent prediction with a highest probability as the input intent for a user interaction. For instance, the morphing interface system 102 determines an input intent to generate an email to a particular recipient, to summarize a document, to book a hotel reservation, to answer a question about a particular topic, to identify user accounts associated with a project, to access a particular content item, or to schedule a meeting. In addition, the morphing interface system 102 generates or identifies the content item 308 based on the input intent.

In some embodiments, the morphing interface system 102 determines an input intent to perform a predefined process using an application installed on a client device or hosted on a server. More particularly, the morphing interface system 102 determines that the input intent is to perform a predefined process corresponding to a button for highly frequent and/or important actions. Accordingly, the morphing interface system 102 performs the predefined process utilizing the large language model 306 to generate or identify the content item 308. For instance, the morphing interface system 102 performs a predefined process to generate the content item 308 in the form of a drafted email to a particular recipient (e.g., a recipient identified via the knowledge graph 304 that includes ontology data indicating the proper recipient, such as a boss or a project lead). As another example, the morphing interface system 102 performs a predefined process to generate the content item 308 in the form of a calendar invite for a scheduled meeting (e.g., automatically scheduled for the user account 302 and other user accounts identified via the knowledge graph 304. As a further example, the morphing interface system 102 identifies the content item 308 as a most recently edited version of a collaborative document (e.g., identified via the knowledge graph 304 indicating recency of edits of content items).

In some embodiments, the morphing interface system 102 monitors user interactions via the intelligent assistant interface and learns repeated and/or frequent interactions over time. In some cases, the morphing interface system 102 learns patterns and trigger events for user interactions and automatically performs processes for the user interactions. For example, the morphing interface system 102 learns a particular trigger event (e.g., the first application session of a workday or a request for weekend building access) based on patterns of user interactions over time. Thus, once a trigger event is learned, the morphing interface system 102 can automatically perform one or more processes upon detecting the trigger event without requiring prompting via the intelligent assistant interface. In some cases, the morphing interface system 102 learns a repeated sequence of user interactions that the user account 302 performs regularly in response to a particular trigger event. Thus, in response to detecting the particular trigger event, the morphing interface system 102 can automatically (e.g., without initiation via user input) perform or execute processes for the sequence of user interactions (without requiring the user interactions).

In one or more embodiments, the morphing interface system 102 determines an input intent to ask a question. More specifically, the morphing interface system 102 receives a user interaction (via the intelligent assistant interface) in the form of a text query that asks a particular question. In response, the morphing interface system 102 utilizes the large language model 306 to generate a response. For example, the morphing interface system 102 processes the text query to determine the question and generates the content item 308 in the form of a response based on model training for the large language model 306 (and/or based on the knowledge graph 304). In some cases, the morphing interface system 102 further modifies the intelligent assistant interface to carry on a conversation with the user account 302, where the user account 302 provides a series of follow-up questions, and the morphing interface system 102 generates responses to the questions.

In one or more embodiments, the morphing interface system 102 determines an input intent to perform a task for a high-order text query—e.g., a task that requires a workflow of computer processes across different applications, systems, and/or networks. In response, the morphing interface system 102 generates the content item 308 in the form of workflow content by executing a series of processes across the different applications, systems, and networks required for the workflow/high-order text query.

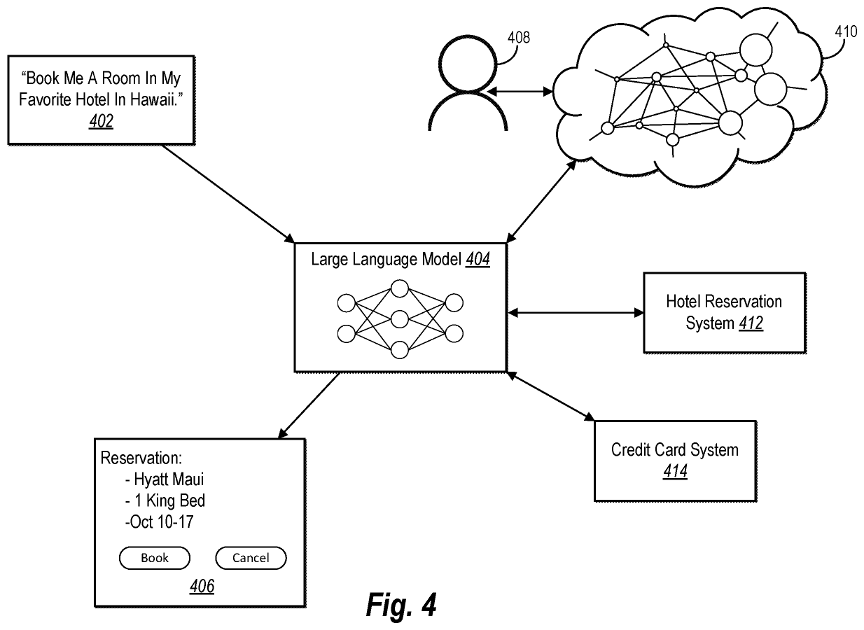

As just mentioned, in certain described embodiments, the morphing interface system 102 generates or identifies a content item as part of a sophisticated multi-application and/or multi-network workflow. In particular, based on determining an input intent to generate or identify a content item that requires multiple computer applications, systems, and/or networks, the morphing interface system 102 utilizes a large language model to execute the workflow by communicating with the multiple applications, systems, and networks. FIG. 4 illustrates an example diagram for executing a high-order workflow in accordance with one or more embodiments.

As illustrated in FIG. 4, the morphing interface system 102 receives a user interaction in the form of a text query 402 (“Book me a room in my favorite hotel in Hawaii.”). In response to receiving the text query via the intelligent assistant interface, the morphing interface system 102 analyzes the text query to determine an input intent. For example, the morphing interface system 102 utilizes a large language model 404 to process the text query 402 to determine that the text query 402 is a workflow prompt for a multi-order query to generate workflow content in the form of a content item using a multi-application workflow. Indeed, the morphing interface system 102 can utilize the large language model 404 to determine that the text query 402 requires more than a single process or more than a single application/network/system to generate or identify the requested content item 406.

Based on determining that the text query 402 prompts a multi-application workflow, the morphing interface system 102 utilizes the large language model 404 to generate subtasks or sub-processes involved in executing the workflow. For example, the morphing interface system 102 determines that the text query 402 involves determining a favorite hotel room in Hawaii for the user account, determining available rooms (e.g., single rooms) in the hotel, and reserving an available room using a credit card associated with the user account 408. Indeed, the morphing interface system 102 can determine sub-processes for multi-application workflows using the large language model 404.

As just mentioned, the morphing interface system 102 executes the sub-processes for the workflow. In particular, the morphing interface system 102 utilizes the large language model 404 to access a knowledge graph 410 associated with a user account 408 (e.g., the user account that provides the text query 402). In particular, the morphing interface system 102 accesses the knowledge graph 410 based on the input intent for text query 402 requesting a hotel reservation at a favorite hotel in Hawaii. Accordingly, the morphing interface system 102 accesses (via the large language model 404) the knowledge graph 410 to determine relationships between the user account 408 and various Hawaiian hotels, based on previous bookings, travel, interactions with content items on the topic, and/or communications with other user accounts indicating favorable or unfavorable reactions different hotels (e.g., for the user account 408 and for other user accounts similar to, or related to, the user account 408).

As further illustrated in FIG. 4, the morphing interface system 102 accesses one or more external (e.g., third-party) systems as part of executing the workflow for the text query 402. In particular, the morphing interface system 102 accesses a hotel reservation system 412 in response to determine which hotel in Hawaii is the favorite for the user account 408 (e.g., the hotel in Hawaii whose node is closest to that of the user account 408). For instance, the morphing interface system 102 utilizes an application programming interface (“API”) for the hotel reservation system 412 to access functions for determining room availability and for reserving rooms. In some embodiments, the hotel reservation system 412 is housed or hosted on a different server than the morphing interface system 102 and/or the large language model 404.

In addition, the morphing interface system 102 accesses a credit card system 414 via an API to utilize functions for submitting payment on behalf of the user account 408 for a hotel reservation. For instance, the morphing interface system 102 provides payment information determined from the credit card system 414 (and/or the knowledge graph 410) to the hotel reservation system 412 for executing payment and booking of a hotel room. In some embodiments, the credit card system 414 is located or housed on a different server than the morphing interface system 102 and/or the large language model 404.

Based on utilizing the hotel reservation system 412 and the credit card system 414, the morphing interface system 102 further generates the content item 406 (e.g., a booking receipt). In particular, the morphing interface system 102 generates a booking receipt that includes information about the hotel reservation. In some embodiments, the morphing interface system 102 further provides selectable interface options for booking or canceling the reservation, while in other embodiments the morphing interface system 102 automatically completes the booking without providing selectable options for approval.

In one or more embodiments, the morphing interface system 102 utilizes the large language model 404 to intelligently adapt generation of the content item 406 based on changes to the text query 402. For example, if the morphing interface system 102 receives a modified version of the text query 402 which states, “Book me a room in my favorite hotel in Hawaii for my next available PTO,” the morphing interface system 102 determines that the reservation dates have bounds. Indeed, the morphing interface system 102 can utilize the large language model 404 to analyze the knowledge graph 410 (which stores data for the user account 408 and/or for an organization of the user account 408) to determine that the next available paid time off (“PTO”) for the user account 408 is October 10-17. Accordingly, the morphing interface system 102 re-accesses the hotel reservation system 412 and the credit card system 414 to cancel the previous booking and to re-book (or to modify the previous booking) the hotel for the PTO dates.

In some embodiments, the morphing interface system 102 executes multi-application workflows using different computer applications installed on a client device and/or hosted on a server. For example, the morphing interface system 102 receives a text query to generate an email that includes an attachment of a generated image. In response, the morphing interface system 102 accesses (an API for) an image editing application to generate the requested digital image and further accesses (an API for) an email application to generate the requested email with the attached image. Indeed, the morphing interface system 102 can utilize the large language model 404 to access and utilize APIs for different applications and systems to execute sophisticated high-order workflows in a variety of fashions.

In one or more embodiments, the morphing interface system 102 can learn to execute workflows for the user account 408. In particular, the morphing interface system 102 can learn to access APIs for external applications and systems based on monitoring user interactions for executing processes of a workflow. For example, if the morphing interface system 102 receives a text query that requires a multi-application workflow unfamiliar to the large language model 404 (e.g., which results in probabilities of generating a correct content item that fail to satisfy a threshold probability), the morphing interface system 102 can request that the user account 408 execute the workflow while the morphing interface system 102 monitors the user interactions to learn the correct execution of the workflow. For example, the morphing interface system 102 detects user interactions with the hotel reservation system 412 and the credit card system 414 and further determines matching information for the selected hotel and payment information from the knowledge graph 410. Accordingly, the morphing interface system 102 learns to execute the workflow for subsequent requests (and further learns information applicable to other workflows).

In some embodiments, the morphing interface system 102 learns APIs for executing processing of computer applications and external systems. For example, the morphing interface system 102 monitors or analyzes computer code for API calls used by other applications and/or coded for various applications and systems to learn the structure and coding grammar rules for particular APIs. By analyzing API calls coded for particular applications and systems, the morphing interface system 102 can thus learn how to generate API calls without such hardcoded calls (e.g., calls coded by a programmer or pre-coded for calling particular API functions).

Based on learning to generate an API call, the morphing interface system 102 can further generate a new (e.g., previously non-existent or uncoded) API call for a particular system or application. Indeed, based on determining an input intent for a user interaction, the morphing interface system 102 can utilize an external application to generate or access a particular content item utilizing a newly generated API call according to the learned grammar and structure. Accordingly, in some cases, the morphing interface system 102 can automatically generate workflow sub-processes for interacting with various applications and systems without needing pre-coded or available API calls.

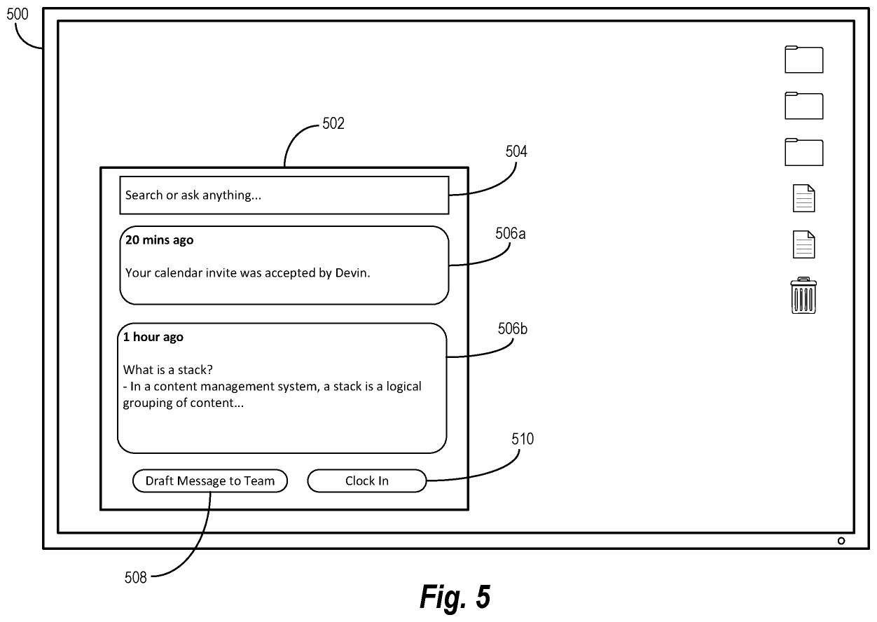

As mentioned above, in certain described embodiments, the morphing interface system 102 generates, provides, and transforms an intelligent application interface for interacting with a large language model. In particular, the morphing interface system 102 provides an intelligent application interface that is adaptive to display content items and interface elements based on contextual data and predicted interaction from a user account. FIGS. 5-9 illustrate example intelligent application interfaces in accordance with one or more embodiments. For example, FIG. 5 illustrates an example intelligent application interface for performing predefined processes in accordance with one or more embodiments.

As illustrated in FIG. 5, the morphing interface system 102 generates and provides an intelligent application interface 502 for display on a client device 500. Within the intelligent application interface 502, the morphing interface system 102 provides a query panel 504 for entering text queries, along with a first update element 506a and a second update element 506b which are selectable to access respective content items (e.g., within respective applications). For instance, the first update element 506a is selectable to view an approved calendar invite (e.g., within a time management application) that was approved 15 minutes ago. In addition, the second update element 506b includes an answer to a question entered via the query panel 504. For instance, the answer is in the form of a summary of a webpage and is selectable to view the webpage defining a stack based on a text query entered 1 hour ago. In some cases, the morphing interface system 102 utilizes a large language model to generate and provide content summaries within the first update element 506a and the second update element 506b.

As further illustrated in FIG. 5, the morphing interface system 102 provides a first interface element 508 and a second interface element 510 for display within the intelligent application interface 502. To elaborate, the morphing interface system 102 provides the first interface element 508 selectable to perform a first predefined process and provides the second interface element 510 selectable to perform a second predefined process. Indeed, the morphing interface system 102 learns or determines processes or actions frequently performed by a user account (and/or by similar user accounts) and modifies the intelligent application interface 502 to include interface elements (e.g., buttons) for the frequent actions. For instance, the morphing interface system 102 generates interface elements for processes requested or performed with at least a threshold frequency. Over time, the morphing interface system 102 updates the intelligent application interface 502 to include and exclude different interface elements for different processes based on changes to user account behavior. For example, the morphing interface system 102 provides the first interface element 508 based on detecting that it is the same time of week that the user account ordinarily messages the team, and the morphing interface system 102 provides the second interface element 510 based on detecting that the user account has logged in for the first time in the morning and has not yet clocked in.

As shown, the morphing interface system 102 generates the first interface element 508 selectable for drafting a message to a team of user accounts. In particular, based on receiving a user interaction selecting the interface element 508, the morphing interface system 102 determines an input intent for the user interaction (e.g., to perform a predefined process of generating a content item to the team of user accounts) and generates a message to a set of user accounts within a team. For example, the morphing interface system 102 utilizes a large language model to analyze a knowledge graph (and/or previously generating messages) to determine recipients for the message as user accounts within a team common to the requesting user account. In addition, the morphing interface system 102 accesses a messaging application (e.g., SLACK) to generate a message to the team. For instance, the morphing interface system 102 generates a message using language that reflects a tone and style of the requesting user account (e.g., as learned over time via the large language model). In some cases, the morphing interface system 102 generates a message with content similar to that of previous messages or as a follow up to previous messages.

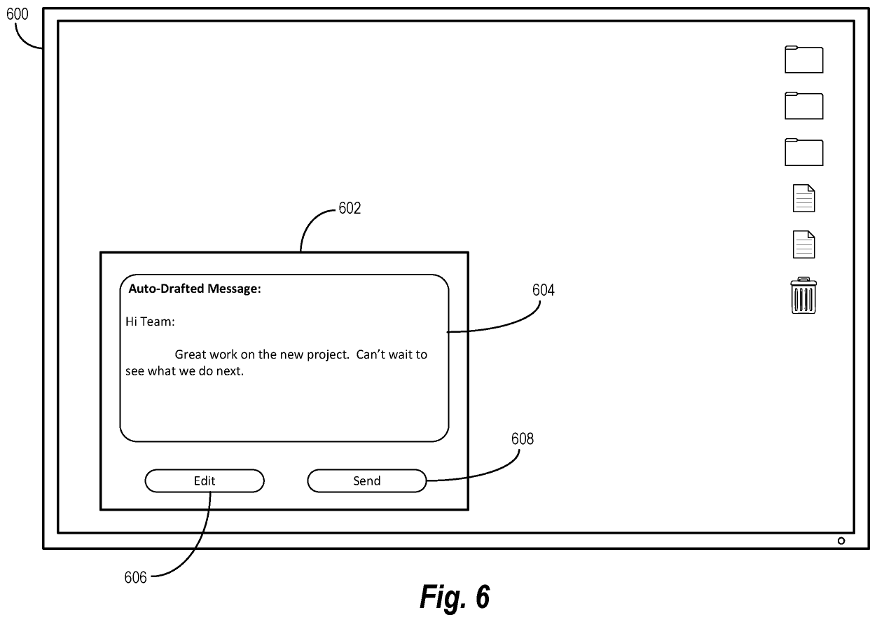

As mentioned, the morphing interface system 102 generates a message in response to user interaction with the first interface element 508. FIG. 6 illustrates a generated message 604 based on such a user interaction. Indeed, the morphing interface system 102 generates a modified or morphed intelligent application interface 602 to include the generated message 604 (or some other content item). As shown, the morphing interface system 102 modifies the intelligent application interface 602 for display on the client device 600 to include the generated message 604 and selectable options. Indeed, the morphing interface system 102 modifies the intelligent application interface 602 to include an edit option 606 and a send option 608 (or other selectable options corresponding to a different content item).

For instance, the morphing interface system 102 provides the edit option 606 that is selectable to edit the generated message 604 (e.g., for editing directly within the intelligent application interface 602). Further, the morphing interface system 102 provides the send option 608 that is selectable to send the message to the recipient accounts. In some cases, the morphing interface system 102 automatically sends the message without providing additional edit options or send options. Specifically, if the morphing interface system 102 generates the message with at least a threshold probability that the message corresponds to a user interaction, then the morphing interface system 102 can send the message without further approval from the user account.

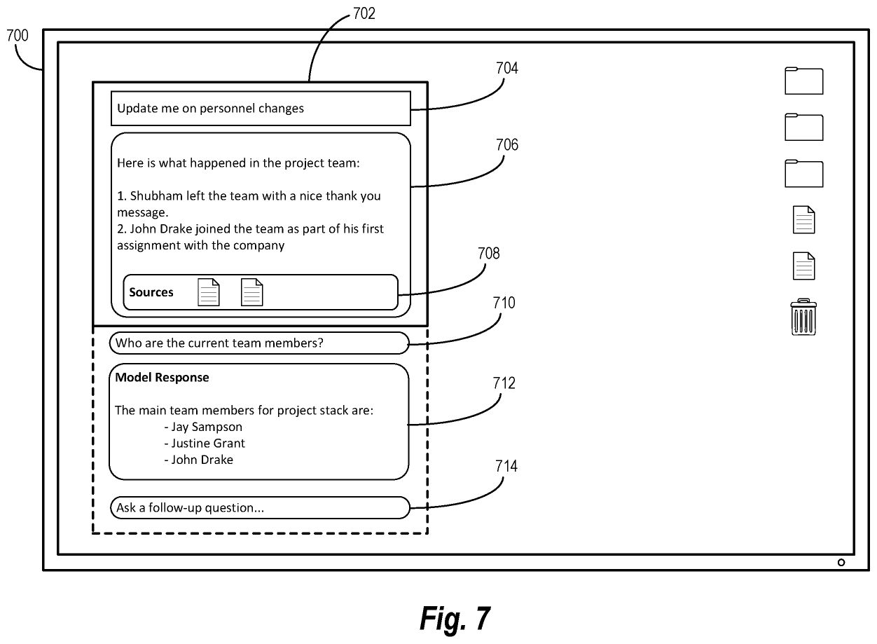

As mentioned above, the morphing interface system 102 can further morph the intelligent application interface 602 for answering questions entered via text queries. FIG. 7 illustrates the client device 700 displaying an intelligent application interface 702 for a question-and-answer interaction. In particular, the morphing interface system 102 receives a text query via a query panel 704 (“Update me on personnel changes”). In response to the text query, the morphing interface system 102 determines an input intent and generates an answer 706 to display within the intelligent application interface 702 (e.g., using a large language model). In addition, the morphing interface system 102 provides a source element 708. In some cases, the answer 706 is selectable to view a more complete or more thorough version of the answer 706 in a larger screen view. Further, the source element 708 is selectable to view one or more content items (e.g., webpages or content items within a knowledge graph) used as sources to generate the answer 706.

In some embodiments, the morphing interface system 102 receives a follow-up question via a query panel 710 (“Who are the current team members?”). In response, the morphing interface system 102 transforms the intelligent application interface 702 by expanding its size to include an additional answer 712 to the follow-up question. To generate the additional answer 712, the morphing interface system 102 can utilize a large language model to analyze the follow-up question within the context of an overall conversation (e.g., a sequence of questions and answers) taking place within the intelligent application interface 702. For example, the morphing interface system 102 can determine that the question “Who are the current team members?” is linked to the answer 706 and the initial question provided via the query panel 704 i.e., that the team members refer to the team members involved in a particular project (e.g., Project Stack).

Accordingly, the morphing interface system 102 generates the additional answer 712 to include selectable user account links for the names of the team members of Project Stack (“Jay Sampson, Justine Grant, and John Drake”). Indeed, the morphing interface system 102 can modify the intelligent application interface 702 during a question-and-answer conversation between a user account and a large language model and can generate contextual data from the conversation to inform the large language model how to generate answers throughout the conversation. As shown, the morphing interface system 102 provides the query panel 714 below the additional answer 712 as the conversation continues.

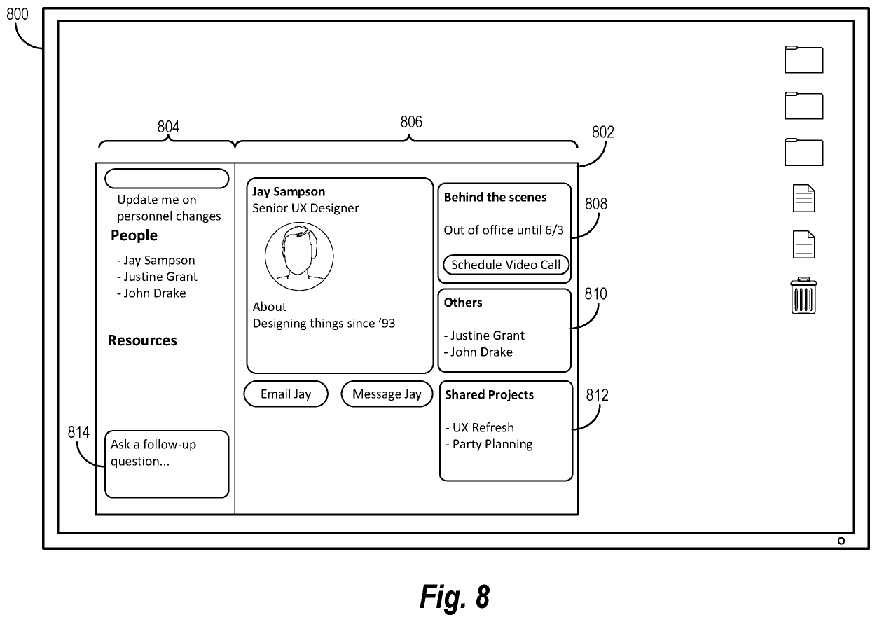

As mentioned above, in some embodiments, the morphing interface system 102 transforms an intelligent application interface to include embedded applications—e.g., windows for interacting directly with external applications directly from the intelligent application interface. In particular, the morphing interface system 102 transforms the size, shape, and function of an intelligent application interface to accommodate embedding an application window according to a particular content item provided for display. FIG. 8 illustrates modifying an intelligent application interface for embedding a web browser application in accordance with one or more embodiments.

As illustrated in FIG. 8, the client device 800 displays an intelligent application interface 802 that includes an intelligent assistant panel 804 and an embedded web browser 806. In particular, the morphing interface system 102 generates a hybrid browser-assistant interface that includes interface elements for interacting with a large language model and that also include web browser interface elements. Indeed, the morphing interface system 102 generates the intelligent application interface 802 in response to a user interaction selecting the “Jay Sampson” link from the intelligent application interface 702 during the question-and-answer conversation. Based on the selection, the morphing interface system 102 determines an input intent to view information about, and/or interact with, the Jay Sampson user account. Accordingly, the morphing interface system 102 accesses and embeds (e.g., via an API) a web browser within the intelligent application interface 802 to provide such functions.

As shown, the morphing interface system 102 transforms the intelligent application interface 802 to include the intelligent assistant panel 804 that includes interface elements for interacting with a large language model (e.g., to the continue the conversation from FIG. 7). In particular, the intelligent assistant panel 804 includes interface elements for providing text queries to the large language model and/or for selecting links or other interface elements to generate or display respective content items (e.g., via corresponding embedded applications). As shown, the intelligent assistant panel 804 includes a query panel 814 along with selectable links for viewing profiles of, and interacting with, user accounts for Jay Sampson, Justine Grant, and John Drake.

As further shown in FIG. 8, the morphing interface system 102 generates the embedded web browser 806 as part of the intelligent application interface 802 to include native web browser functions. For example, the morphing interface system 102 accesses a URL indicated by the Jay Sampson link and displays the content item hosted at the URL within the embedded web browser 806, including selectable options to communication with Jay Sampson and navigate the profile page. As shown, the embedded web browser 806 includes a profile page for Jay Sampson.

As part of the hybrid assistant-browser interface (e.g., the intelligent application interface 802), the morphing interface system 102 can modify or augment the embedded web browser 806. More specifically, the morphing interface system 102 can augment the embedded web browser 806 to include hybrid assistant-browser interface elements that incorporate data (and/or function) from a web browser and data (and/or function) from a large language model.

For example, the morphing interface system 102 generates the interface element 808 by utilizing a large language model to analyze a knowledge graph to determine information about Jay Sampson. Indeed, the morphing interface system 102 determines that Jay Sampson is out office until 6/3 based on a meeting schedule and/or based on user account activity data. Additionally, the morphing interface system 102 provides a selectable option for scheduling a video call with Jay Sampson. For instance, based on detecting a selection of the meeting option, the morphing interface system 102 utilizes a large language model to access knowledge graph data about Jay Sampson and about the requesting user account to determine matching availabilities to generate and provide a content item in the form of a set of potential meeting times for confirmation (e.g., via the intelligent application interface 802). In some cases, the morphing interface system 102 further utilizes an external calendar application to determine availabilities and to schedule the meeting.

As further illustrated in FIG. 8, the morphing interface system 102 generates a hybrid browser-assistant interface element 810. In particular, the morphing interface system 102 generates the interface element 810 by identifying user accounts (e.g., from a knowledge graph) that are similar, and/or related, to Jay Sampson. For example, the morphing interface system 102 utilizes a large language model to determine a relatedness between user accounts based on contextual data from an ongoing question-and-answer conversation within the intelligent application interface 802 (e.g., as shown in FIG. 7). Indeed, the morphing interface system 102 can determine, based on previous text queries (or other user interactions) within the intelligent application interface 802, user accounts related to Jay Sampson within the context of the previous queries/interactions (e.g., regarding a shared project, such as Project Stack).

As also shown in FIG. 8, the morphing interface system 102 generate a hybrid browser-assistant interface element 812. More specifically, the morphing interface system 102 generates the interface element 812 to indicate content items or past projects shared by Jay Sampson and the requesting user account. Indeed, the morphing interface system 102 determines past projects based on large language model data. For example, the morphing interface system 102 utilizes a large language model to determine, from a knowledge graph and/or from historical user account behavior, which previous projects both Jay Sampson and the requesting user account worked on. Specifically, the morphing interface system 102 identifies historical user interactions for both Jay Sampson and the requesting account with content items belonging to a common project. More particularly, the morphing interface system 102 determines a set of user interactions for both accounts, where at least a subset of the user interactions overlapped within a timeline of the project to ensure that both user accounts were working on the project at the same time. In some cases, the morphing interface system 102 further identifies past communications between the user accounts and/or collaborative content items with access shared by the user accounts.

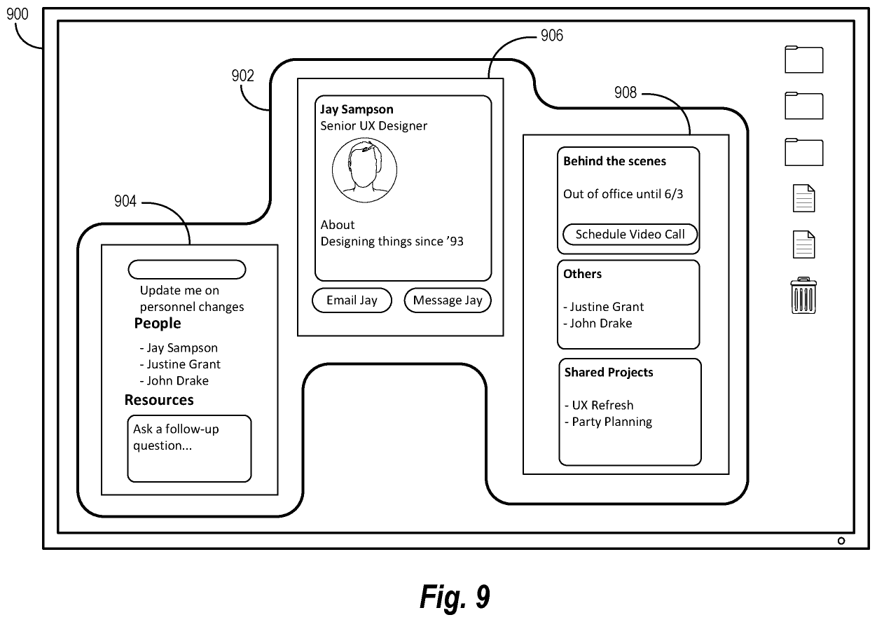

As mentioned above, in some embodiments, the morphing interface system 102 transforms a size, shape, and function of an intelligent application interface. In particular, the morphing interface system 102 transforms the intelligent application interface based on a content type of a content item to display and/or based on an embedded application for presenting a content item. FIG. 9 illustrates modifying a size and shape of an intelligent application interface in accordance with one or more embodiments.

As illustrated in FIG. 9, the client device 900 displays an intelligent application interface 902 that includes an intelligent interface panel 904, an embedded web browser 906, and a hybrid browser-assistant panel 908. Indeed, the morphing interface system 102 can transform a shape of the intelligent application interface 902 based on determining that embedding a web browser is necessary to display or present a particular content item in response to user interaction via the intelligent application interface 902. In some cases, the morphing interface system 102 transforms the shape of the intelligent application interface 902 to visually separate different components of the intelligent application interface 902, such as the intelligent interface panel 904, the embedded web browser 906, and the hybrid browser-assistant panel 908.

In some cases, the morphing interface system 102 transforms the intelligent application interface 902 into different shapes for different (types of) content items and/or for embedding different applications. For example, the morphing interface system 102 can transform the intelligent application interface 902 into a first shape for the embedded web browser 906 and can transform the intelligent application interface 902 into a second shape for an embedded email client or an embedded image editor (or some other application).

In addition to transforming a size and a shape of the intelligent application interface 902 for different content items and/or embedded applications, the morphing interface system 102 can further transform functions as well. For example, the morphing interface system 102 can remove (or modify) the hybrid browser-assistant panel 908 and replace it with a hybrid editor-assistant panel or a hybrid email-assistant panel or some other hybrid panel for integrating large language model functions with external application functions. For instance, the morphing interface system 102 can generate a hybrid panel that includes selectable options for generating emails to frequent recipients relating to a particular topic of a text query within the intelligent application interface 902 (e.g., Project Stack). As another example, the morphing interface system 102 can generate a hybrid panel that includes an element for automatically modifying a digital image to match a request indicated by a text query.

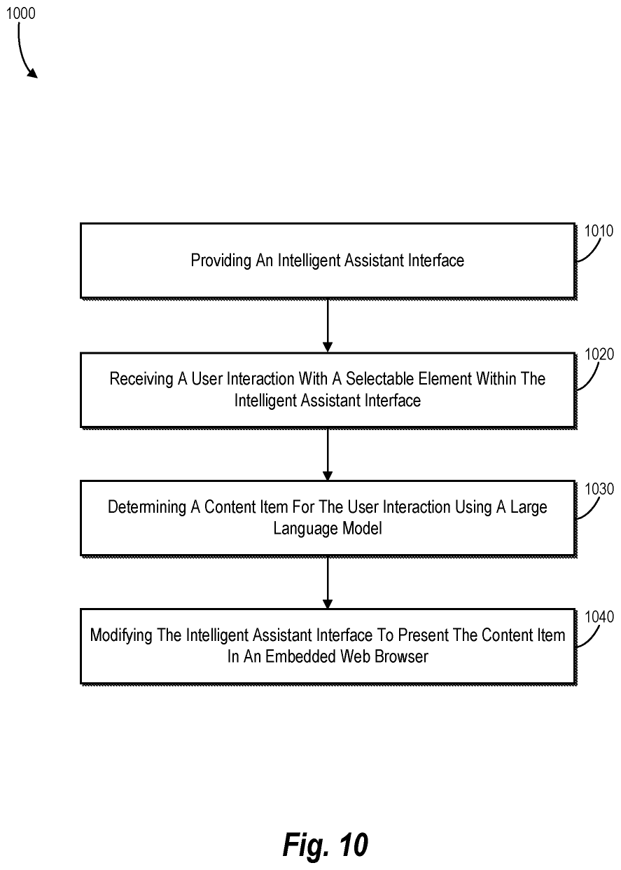

FIGS. 1-9, the corresponding text, and the examples provide a number of different systems and methods for generating, providing, and transforming an intelligent application interface. In addition to the foregoing, implementations can also be described in terms of flowcharts comprising acts steps in a method for accomplishing a particular result. For example, FIG. 10 illustrates an example series of acts for generating, providing, and transforming an intelligent application interface in accordance with one or more embodiments.

While FIG. 10 illustrates acts according to certain implementations, alternative implementations may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further implementations, a system can perform the acts of FIG. 10.

As illustrated in FIG. 10, the series of acts 1000 may include an act 1010 of providing an intelligent application interface. In particular, the act 1010 can involve providing, for display on a client device, an intelligent assistant interface comprising a selectable element for interacting with a large language model, wherein the selectable element comprises one or more of a query panel for entering text queries or an action element selectable for performing a process using a separate computer application. In addition, the series of acts 1000 can include an act 1020 of receiving a user interaction with a selectable element within the intelligent application interface, wherein the user interaction comprises one or more of entering a text query or selecting an action element via the intelligent assistant interface. In particular, the act 1020 can involve receiving, from the client device, an indication of a user interaction with the selectable element of the intelligent assistant interface. Further, the series of acts 1000 can include an act 1030 of determining a content item for the user interaction using a large language model. In particular, the act 1030 can involve determining a content item to provide to the client device in response to the user interaction by utilizing the large language model to analyze a knowledge graph defining relationships among content items and user accounts of a content management system. Additionally, the series of acts 1040 can involve modifying the intelligent assistant interface to present the content item in an embedded web browser. In particular, the act 1040 can involve, based on determining the content item to provide to the client device, modifying the intelligent assistant interface to present an embedded web browser for displaying the content item together with selectable elements for interacting with the large language model.

In some embodiments, the series of acts 1000 includes an act of providing the intelligent assistant interface by providing a floating panel for display on the client device, wherein the floating panel includes a query panel for entering text queries and one or more action elements selectable for performing respective processes via computer applications. Indeed, the series of acts 1000 can include an act of providing a floating panel for display on the client device, wherein the floating panel includes a query panel for entering text queries and one or more action elements selectable for performing respective processes via computer applications. In these or other embodiments, the series of acts 1000 includes an act of receiving the indication of the user interaction with the selectable element by one or more of: receiving a selection of an action element for performing a predefined process utilizing an application installed on the client device or hosted on a server, receiving a text question for generating a response utilizing the large language model, or receiving a workflow prompt for generating workflow content by performing multiple processes utilizing multiple applications housed on different servers connected by a network.

In certain embodiments, the series of acts 1000 includes an act of determining the content item to provide in response to the user interaction by: utilizing the large language model to determine an input intent by processing the user interaction from the client device and identifying the content item corresponding to the input intent by analyzing the knowledge graph to perform a predefined process via an application installed on the client device or hosted on a server. In some cases, the series of acts 1000 includes an act of determining the content item to provide in response to the user interaction by: utilizing the large language model to determine an input intent by processing the user interaction from the client device and utilizing the large language model to generate a response by analyzing the knowledge graph to determine graph information corresponding to the input intent for the response.

The series of acts 1000 can include an act of determining the content item to provide in response to the user interaction by: utilizing the large language model to determine an input intent by processing the user interaction from the client device and generating workflow content based on the input intent by utilizing multiple computer applications to perform a sequence of successive processes that build on one another to generate the workflow content based on the knowledge graph. The series of acts 1000 can also include an act of modifying the intelligent assistant interface to present the embedded web browser by generating a hybrid assistant-browser interface that includes a first area dedicated to the embedded web browser for displaying the content item and a second area dedicated to the intelligent assistant interface that includes the selectable elements for interacting with the large language model.

Additionally, the series of acts 1000 can include an act of generating the knowledge graph by: determining the relationships among the content items and the user accounts according to account behavior for a particular user account of the content management system, arranging nodes representing the user accounts and the content items within the content management system separated by distances reflecting the relationships defined by the account behavior of the particular user account, and connecting the nodes with edges defined by the distances between the nodes. Further, the series of acts 1000 can include an act of learning a repeated sequence of user interactions over time and an act of automatically performing processes for the repeated sequence of user interactions without initiation by user input based on detecting a trigger event.

In some embodiments, the series of acts 1000 includes an act of generating a new action element to add to the intelligent assistant interface for the repeated sequence of user interactions. The series of acts 1000 can also include an act of determining the content item to provide in response to the user interaction by: utilizing the large language model to determine an input intent by processing the user interaction from the client device and utilizing the large language model to generate a response by analyzing the knowledge graph to determine graph information corresponding to the input intent for the response.

In certain cases, the series of acts 1000 includes an act of modifying the intelligent assistant interface to present the embedded web browser in response to determining that the content item from the knowledge graph is located at a server location displayable via a browser interface. The series of acts 1000 can include an act of modifying the intelligent assistant interface to present the embedded web browser by generating a hybrid assistant-browser interface that includes a first area dedicated to the embedded web browser for displaying the content item and a second area dedicated to the intelligent assistant interface that includes the selectable elements for interacting with the large language model.

The series of acts 1000 can also include an act of, based on automatically generating the content item, providing an edit option for editing the content item before providing to another client device. The series of acts 1000 can include an act of modifying the intelligent assistant interface to present the embedded web browser in response to determining that the content item from the knowledge graph is located at a server location displayable via a browser interface.

The components of the morphing interface system 102 can include software, hardware, or both. For example, the components of the morphing interface system 102 can include one or more instructions stored on a computer-readable storage medium and executable by processors of one or more computing devices. When executed by one or more processors, the computer-executable instructions of the morphing interface system 102 can cause a computing device to perform the methods described herein. Alternatively, the components of the morphing interface system 102 can comprise hardware, such as a special purpose processing device to perform a certain function or group of functions. Additionally or alternatively, the components of the morphing interface system 102 can include a combination of computer-executable instructions and hardware.

Furthermore, the components of the morphing interface system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the morphing interface system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of exemplary computing device 1100 (e.g., the server(s) 104 and/or the client device 108) that may be configured to perform one or more of the processes described above. One will appreciate that server(s) 104 and/or the client device 108 may comprise one or more computing devices such as computing device 1100. As shown by FIG. 11, computing device 1100 can comprise processor 1102, memory 1104, storage device 1106, I/O interface 1108, and communication interface 1110, which may be communicatively coupled by way of communication infrastructure 1112. While an exemplary computing device 1100 is shown in FIG. 11, the components illustrated in FIG. 11 are not intended to be limiting. Additional or alternative components may be used in other implementations. Furthermore, in certain implementations, computing device 1100 can include fewer components than those shown in FIG. 11. Components of computing device 1100 shown in FIG. 11 will now be described in additional detail.

In particular implementations, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular implementations, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage device 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, storage device 1106 can comprise a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to computing device 1100. In particular implementations, storage device 1106 is non-volatile, solid-state memory. In other implementations, Storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1108 is configured to provide graphical data to a display for presentation to a user. The graphical data may be representative of one or more graphical user interfaces and/or any other graphical content as may serve a particular implementation.

Communication interface 1110 can include hardware, software, or both. In any event, communication interface 1110 can provide one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 12 is a schematic diagram illustrating environment 1200 within which one or more implementations of the morphing interface system 102 can be implemented. For example, the morphing interface system 102 may be part of a content management system 1202 (e.g., the content management system 106). Content management system 1202 may generate, store, manage, receive, and send digital content (such as digital content items). For example, content management system 1202 may send and receive digital content to and from client devices 1206 by way of network 1204. In particular, content management system 1202 can store and manage a collection of digital content. Content management system 1202 can manage the sharing of digital content between computing devices associated with a plurality of users. For instance, content management system 1202 can facilitate a user sharing a digital content with another user of content management system 1202.

In particular, content management system 1202 can manage synchronizing digital content across multiple client devices 1206 associated with one or more users. For example, a user may edit digital content using client device 1206. The content management system 1202 can cause client device 1206 to send the edited digital content to content management system 1202. Content management system 1202 then synchronizes the edited digital content on one or more additional computing devices.

In addition to synchronizing digital content across multiple devices, one or more implementations of content management system 1202 can provide an efficient storage option for users that have large collections of digital content. For example, content management system 1202 can store a collection of digital content on content management system 1202, while the client device 1206 only stores reduced-sized versions of the digital content. A user can navigate and browse the reduced-sized versions (e.g., a thumbnail of a digital image) of the digital content on client device 1206. In particular, one way in which a user can experience digital content is to browse the reduced-sized versions of the digital content on client device 1206.

Another way in which a user can experience digital content is to select a reduced-size version of digital content to request the full- or high-resolution version of digital content from content management system 1202. In particular, upon a user selecting a reduced-sized version of digital content, client device 1206 sends a request to content management system 1202 requesting the digital content associated with the reduced-sized version of the digital content. Content management system 1202 can respond to the request by sending the digital content to client device 1206. Client device 1206, upon receiving the digital content, can then present the digital content to the user. In this way, a user can have access to large collections of digital content while minimizing the amount of resources used on client device 1206.

Client device 1206 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1204.

Network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1206 may access content management system 1202.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
providing, for display on a client device, an intelligent assistant interface comprising a selectable element for interacting with a large language model;
receiving, from the client device, an indication of a user interaction with the selectable element of the intelligent assistant interface;
determining a content item to provide to the client device in response to the user interaction by utilizing the large language model to analyze a knowledge graph defining relationships among content items and user accounts of a content management system; and
based on determining the content item to provide to the client device, modifying the intelligent assistant interface to present an embedded web browser for displaying the content item together with selectable elements for interacting with the large language model.

2. The method of claim 1, wherein providing the intelligent assistant interface comprises providing a floating panel for display on the client device, wherein the floating panel includes a query panel for entering text queries and one or more action elements selectable for performing respective processes via computer applications.

3. The method of claim 1, wherein receiving the indication of the user interaction with the selectable element comprises one or more of:
receiving a selection of an action element for performing a predefined process utilizing an application installed on the client device or hosted on a server;
receiving a text question for generating a response utilizing the large language model; or
receiving a workflow prompt for generating workflow content by performing multiple processes utilizing multiple applications housed on different servers connected by a network.

4. The method of claim 1, wherein determining the content item to provide in response to the user interaction comprises:
utilizing the large language model to determine an input intent by processing the user interaction from the client device; and
identifying the content item corresponding to the input intent by analyzing the knowledge graph to perform a predefined process via an application installed on the client device or hosted on a server.

5. The method of claim 1, wherein determining the content item to provide in response to the user interaction comprises:
utilizing the large language model to determine an input intent by processing the user interaction from the client device; and
utilizing the large language model to generate a response by analyzing the knowledge graph to determine graph information corresponding to the input intent for the response.

6. The method of claim 1, wherein determining the content item to provide in response to the user interaction comprises:
utilizing the large language model to determine an input intent by processing the user interaction from the client device; and
generating workflow content based on the input intent by utilizing multiple computer applications to perform a sequence of successive processes that build on one another to generate the workflow content based on the knowledge graph.

7. The method of claim 1, wherein modifying the intelligent assistant interface to present the embedded web browser comprises generating a hybrid assistant-browser interface that includes a first area dedicated to the embedded web browser for displaying the content item and a second area dedicated to the intelligent assistant interface that includes the selectable elements for interacting with the large language model.

8. A system comprising:
at least one processor; and
a non-transitory computer readable medium comprising instructions that, when executed by the at least one processor, cause the system to:
provide, for display on a client device, an intelligent assistant interface comprising a selectable element for interacting with a large language model, wherein the selectable element comprises one or more of a query panel for entering text queries or an action element selectable performing a process using a separate computer application;
receive, from the client device, an indication of a user interaction with the selectable element of the intelligent assistant interface;
determine a content item to provide to the client device in response to the user interaction by utilizing the large language model to analyze a knowledge graph defining relationships among content items and user accounts of a content management system; and
based on determining the content item to provide to the client device, modify the intelligent assistant interface to present an embedded web browser for displaying the content item together with selectable elements for interacting with the large language model.

9. The system of claim 8, further comprising instructions that, when executed by the at least one processor, cause the system to generate the knowledge graph by:
determining the relationships among the content items and the user accounts according to account behavior for a particular user account of the content management system;
arranging nodes representing the user accounts and the content items within the content management system separated by distances reflecting the relationships defined by the account behavior of the particular user account; and
connecting the nodes with edges defined by the distances between the nodes.

10. The system of claim 8, further comprising instructions that, when executed by the at least one processor, cause the system to:
learn a repeated sequence of user interactions over time; and
automatically perform processes for the repeated sequence of user interactions without initiation by user input based on detecting a trigger event.

11. The system of claim 10, further comprising instructions that, when executed by the at least one processor, cause the system to generate a new action element to add to the intelligent assistant interface for the repeated sequence of user interactions.

12. The system of claim 8, further comprising instructions that, when executed by the at least one processor, cause the system to determine the content item to provide in response to the user interaction by:
utilizing the large language model to determine an input intent by processing the user interaction from the client device; and
utilizing the large language model to generate a response by analyzing the knowledge graph to determine graph information corresponding to the input intent for the response.

13. The system of claim 8, further comprising instructions that, when executed by the at least one processor, cause the system to modify the intelligent assistant interface to present the embedded web browser in response to determining that the content item from the knowledge graph is located at a server location displayable via a browser interface.

14. The system of claim 8, further comprising instructions that, when executed by the at least one processor, cause the system to modify the intelligent assistant interface to present the embedded web browser by generating a hybrid assistant-browser interface that includes a first area dedicated to the embedded web browser for displaying the content item and a second area dedicated to the intelligent assistant interface that includes the selectable elements for interacting with the large language model.

15. A non-transitory computer readable medium comprising instructions that, when executed by at least one processor, cause the at least one processor to:
provide, for display on a client device, an intelligent assistant interface comprising a selectable element for interacting with a large language model;
receive, from the client device, an indication of a user interaction with the selectable element of the intelligent assistant interface, wherein the user interaction comprises one or more of entering a text query or selecting an action element via the intelligent assistant interface;
determine a content item to provide to the client device in response to the user interaction by utilizing the large language model to analyze a knowledge graph defining relationships among content items and user accounts of a content management system; and
based on determining the content item to provide to the client device, modify the intelligent assistant interface to present an embedded web browser for displaying the content item together with selectable elements for interacting with the large language model.

16. The non-transitory computer readable medium of claim 15, further comprising instructions that, when executed by the at least one processor, cause the at least one processor to provide the intelligent assistant interface by providing a floating panel for display on the client device, wherein the floating panel includes a query panel for entering text queries and one or more action elements selectable for performing respective processes via computer applications.

17. The non-transitory computer readable medium of claim 15, further comprising instructions that, when executed by the at least one processor, cause the at least one processor to:
learn a repeated sequence of user interactions over time; and
automatically perform the repeated sequence of user interactions to generate the content item without initiation by user input based on detecting a trigger event.

18. The non-transitory computer readable medium of claim 17, further comprising instructions that, when executed by the at least one processor, cause the at least one processor to, based on automatically generating the content item, provide an edit option for editing the content item before providing to another client device.

19. The non-transitory computer readable medium of claim 15, further comprising instructions that, when executed by the at least one processor, cause the at least one processor to modify the intelligent assistant interface to present the embedded web browser in response to determining that the content item from the knowledge graph is located at a server location displayable via a browser interface.

20. The non-transitory computer readable medium of claim 15, further comprising instructions that, when executed by the at least one processor, cause the at least one processor to modify the intelligent assistant interface to present the embedded web browser by generating a hybrid assistant-browser interface that includes a first area dedicated to the embedded web browser for displaying the content item and a second area dedicated to the intelligent assistant interface that includes the selectable elements for interacting with the large language model.
